(19) United States
(12) Patent Application Publication
(10) Pub. No.: US 2006/0215985 A1
(43) Pub. Date: Sep. 28, 2006

(54) Data recording/reproducing device, data processing method and program

(76) Inventor: Yoshimi Enomoto, Kashiwa-shi (JP)

Correspondence Address: PHILIPS INTELLECTUAL PROPERTY & STANDARDS, P.O. BOX 3001, BRIARCLIFF MANOR, NY, 10510, US

(21) Appl. No.: 10/551,972

(22) PCT Filed: Apr. 5, 2004
(86) PCT No.: PCT/IB04/01059

§ 371 Date: Oct. 5, 2005

(30) Foreign Application Priority Data
Apr. 10, 2003 (IB) IB03/01482

(51) Int. Cl. H04N 5/91

(52) U.S. Cl. 386/46

(57) ABSTRACT

Permanent recording is prohibited when copy control information with never copy information is added to an audio-visual signal (SAViₙ) inputted to a processor (10), so that temporary recording is made possible in more situations. A data recording/reproducing device of this invention is provided with a means for determining whether or not the video data is to be recorded with changing from a permanent recording mode to a temporary recording mode, without recording being performed in the permanent recording mode, when never copy information and information of the permanent recording mode are received as additional information. The data recording/reproducing device is further provided with a means for instructing to record the video data on a recording portion (15) in the temporary recording mode when it is determined by the determining means to record the video data with changing to the temporary recording mode.

### BACKGROUND OF THE INVENTION

1. Field of the Invention

The present invention relates to a data recording/reproducing device provided with a processor for receiving data including video data, first additional information to control a copy of the video data and second additional information to control a type of recording and/or reproducing the video data and for processing the received data, the processor having a recording portion capable of carrying out recording in a permanent recording mode for permanently recording the received video data or in a temporary recording mode for temporarily recording the received video data, and data processing method and program associated therewith.

2. Description of Related Art

There is a growing demand for so-called time shift reproduction which temporarily stops viewing a TV program being broadcast (on air) and resumes it or records a TV program being broadcast and reproduces the TV program at an arbitrary time from the beginning. Furthermore, a data recording/reproducing device provided with a randomly accessible recording medium such as a hard disk drive, capable of the -above-described time shift reproduction is becoming widespread. Such data recording/reproducing device is normally provided, as a format for recording data in the recording medium, with a temporary recording mode for temporarily recording data related to the time shift reproduction and a permanent recording mode for permanently recording data related to other than the time shift reproduction.

When an audiovisual signal such as TV broadcasting is inputted to the above-described data recording/reproducing device, copy control information such as a macrovision signal or CGMS (Copy Generation Management System) data, etc., is generally added to this audiovisual signal to prevent illegal copies of the signal. A data recording/reproducing device currently on the market is designed to be able to carry out permanent recording or temporary recording when copy control information with copy permission information is added to an audiovisual input signal and carry out neither permanent recording nor temporary recording when copy control information with never copy information is added to the audiovisual signal. In contrast to this, there is a strong demand for, when copy control information with never copy information is added to an audiovisual signal inputted, prohibiting only permanent recording and enabling temporary recording.

Thus, when a digital content is recorded as digital data, there is a proposal on a device capable of reflecting the intention of “never copy” of a program supplier and allowing the user to view the program at a time later than the time at which the TV program is broadcast even if an audiovisual signal with copy control information with never copy added is inputted (e.g., see International Publication No. WO99/46933 pamphlet, Unexamined Japanese Patent Publication No. 2001-245223).

However, the devices disclosed in these publications have a problem that the above-described demands cannot be completely satisfied; for example, there is a limit to cases where temporary recording is available. Furthermore, there is a difference in the accompanying information when data is recorded as digital data and when an analog input signal is recorded (see the specification of Japanese Patent Application No. 2002-378245), and therefore there is another problem that the device proposed in the above-described document cannot be applied to processing of analog signals. Therefore, there is still a strong demand for realizing time shift reproduction when an analog audiovisual input signal accompanied by never copy information is inputted.

### SUMMARY OF THE INVENTION

The present invention has been implemented in view of the above-described problems and it is a first object of the present invention to provide a data recording/reproducing device, data processing method and program capable of prohibiting permanent recording when copy control information with never copy information is added to an audiovisual signal inputted to a processor and enabling temporary recording in more situations.

It is a second object of the present invention to provide a data recording/reproducing device, data processing method and program capable of reflecting the intention of “never copy” of a program supplier and carrying out time shift reproduction when never copy information is added to an analog audiovisual signal inputted to the processor.

The data recording/reproducing device according to the present invention is a data recording/reproducing device provided with a processor for receiving data including video data, first additional information to control a copy of the video data and second additional information to control a type of recording and/or reproducing the video data and for processing the received data, the processor having a recording portion capable of carrying out recording in a permanent recording mode for permanently recording the received video data or in a temporary recording mode for temporarily recording the received video data, characterized in that the processor comprises a means for determining whether or not the video data is to be recorded with changing from the permanent recording mode to the temporary recording mode, without recording being performed in the permanent recording mode, when never copy information is received as the first additional information and information of the permanent recording mode is received as the second additional information and a means for instructing to record the video data on the recording portion in the temporary recording mode when it is determined by the determining means to record the video data with changing to the temporary recording mode.

The data processing method of the present invention is a data processing method including a processing step of processing input data including video data, first additional information to control a copy of the video data and second additional information to control a type of recording and/or reproducing the video data, in which processing step recording can be carried out in a permanent recording mode for permanently recording the received video data or in a temporary recording mode for temporarily recording the received video data, characterized in that the processing step includes the steps of determining whether or not the video data is to be recorded with changing from the permanent recording mode to the temporary recording mode, without recording being performed in the permanent recording mode, when never copy information is received as the first additional information and information of the permanent recording mode is received as the second additional information and instructing to record the video data in the temporary recording mode when it is determined by the determining step to record the video data with changing to the temporary recording mode.

The program of the present invention is a program operable on a computer for processing data including video data, first additional information to control a copy of the video data and second additional information to control a type of recording and/or reproducing the video data, characterized in that the program comprises the functions for determining whether or not the video data is to be recorded with changing from a permanent recording mode to a temporary recording mode, without recording being performed in the permanent recording mode, when never copy information is received as the first additional information and information of the permanent recording mode is received as the second additional information and instructing to record the video data in the temporary recording mode when it is determined by the determining function to record the video data with changing to the temporary recording mode.

According to the data recording/reproducing device, data processing method or program of the present invention, when additional information with never copy information is added to the video data inputted to the processor, permanent recording is not carried out and temporary recording is carried out with changing from a permanent recording mode to a temporary recording mode. Furthermore, this increases the degree of freedom in utilization by the user.

The above-described processor of the data recording/reproducing device of the present invention preferably has an ability to perform recording and reproducing at the same time, and further comprises a means for instructing to start reproducing the video data temporarily recorded on the recording portion before the end of recording in the temporary recording mode when the change from the permanent recording mode to the temporary recording mode is made and a means for erasing the video data in the recording portion immediately after information about stop of recording in the temporary recording mode is received. Even if analog video data accompanied by additional information with never copy information is inputted, this allows time shift reproduction to be performed without the data temporarily recorded in the recording portion being copied.

The other objects, features and advantages of the invention will become sufficiently apparent from the following detailed description of a preferred embodiment of the invention.

### BRIEF DESCRIPTION OF DRAWINGS

FIG. 1 is a block diagram illustrating a functional structure of a processor of a data recording/reproducing device according to an embodiment of the invention;

FIG. 2 is a flowchart for explaining an operation of the data recording/reproducing device shown in FIG. 1; and

FIG. 3 is another flowchart for explaining an operation of the data recording/reproducing device shown in FIG. 1.

### DESCRIPTION OF THE PREFERRED EMBODIMENT(S)

With reference now to the attached drawings, an embodiment of the present invention will be explained in detail below.

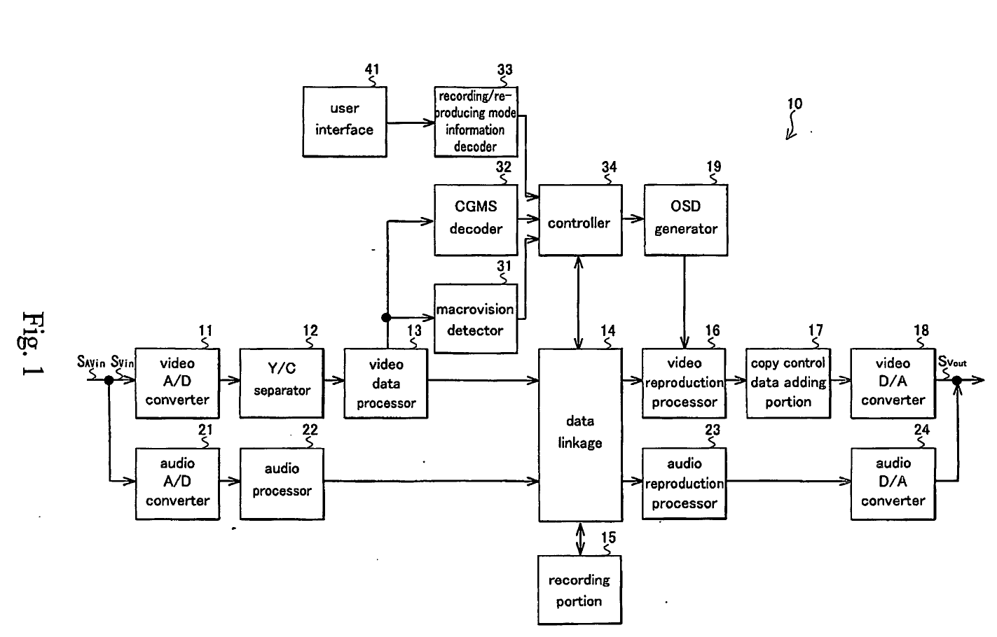

First, a structure of a data recording/reproducing device according to an embodiment of the present invention will be explained with reference to FIG. 1.

The data recording/reproducing device according to this embodiment is provided with a processor for receiving data including analog video data, copy control information to control a copy of the video data and recording/reproducing mode information to control a mode of recording/reproducing the video data and for processing the received data Furthermore, the data recording/reproducing device can record and reproduce video data at the same time and, based on the recording/reproducing mode information, can operate in a permanent recording mode for permanently recording data, in a temporary recording mode for temporarily recording data and in a reproducing mode (more specifically, direct reproducing mode and read reproducing mode which will be described later). An example of such a data recording/reproducing device is a television set provided with a recording medium capable of digital recording such as an HDD (hard disk drive). Here, a case where data with CGMS data added as copy control information and analog (NTSC) audiovisual signal S_{AVin} with a macrovision signal added as required are inputted will be explained. The CGMS data is used to determine whether a copy of the video signal received by the data recording/reproducing device is to be permitted or prohibited and the macrovision signal is used to prevent the video signal from being recorded normally.

FIG. 1 is a block diagram illustrating a functional structure of a processor 10. The processor 10 comprises a video A/D converter 11 that converts a video signal S_{Vin} of an inputted analog AV input signal S_{AVin} to a digital signal, a Y/C separator 12 that separates a brightness (Y) signal component and color (C) signal component from the digital-converted video data, a video data processor 13 that carries out processing such as color demodulation using the brightness signal and color signal, generates a color difference signal and extracts a portion to which the CGMS data and macrovision signal should have been added (hereinafter referred to as “macrovision signal added portion”), an audio A/D converter 21 that converts an analog audio input signal S_{Ain} of an inputted analog AV input signal S_{AVin} to a digital signal, an audio processor 22 that formats the digital-converted audio data, a data linkage 14 that supplies the color difference signal generated by the video data processor 13 and the audio data processed by the audio processor 22 and a recording portion 15 that records the video data and audio data in the above-described permanent recording mode or temporary recording mode.

The recording portion 15 comprises reproduced data erasing means for erasing, in a temporary recording mode, temporarily recorded and reproduced video data from the recording portion 15 immediately after the reproduction and temporarily recorded data erasing means for erasing, in a temporary recording mode, the temporarily recorded video data of the recording portion 15 when reproduction of the temporarily recorded video data is not started before the end of recording and when reproduction of the temporarily recorded video data is not carried out at the end of recording. The reproduced data erasing means may also be provided so as to erase data collectively immediately after reproduction of the reproduced data of the program is completed or erase data reproduced sequentially at the same time as the reproduction (see the specification of Japanese Patent Application No. 2002-378245).

The processor 10 also comprises a macrovision detector 31 that receives the macrovision signal added portion extracted by the video data processor 13 and detects the presence/absence, etc., of the macrovision signal, a CGMS decoder 32 that receives the CGMS data extracted by the video data processor 13 and decodes this CGMS data, a recording/reproducing mode information decoder 33 that receives recording/reproducing mode information sent from a remote controller forming a part of the apparatus or a user interface 41 such as operation keys and decodes this recording/reproducing mode information and a controller 34 supplied with the CGMS data from the CGMS decoder 32 and the recording/reproducing mode information from the recording/reproducing mode information decoder 33. The CGMS data supplied to the controller 34 indicates any one of copy free, only one-generation copy allowed, no more copy and never copy. Furthermore, the recording/reproducing mode information supplied to the controller 34 indicates any one of the above-described permanent recording mode, the above-described temporary recording mode, a direct reproducing mode in which an input analog video signal S_{Vin} is directly reproduced and a read reproducing mode in which the video data and audio data recorded in the recording portion 15 are read and reproduced.

The controller 34 receives information of copy prohibited (e.g., “no more copy” or “never copy” in the above-described CGMS data) as the copy control information and comprises determining means for determining, when permanent recording mode information is inputted as the recording/reproducing mode information, whether or not the corresponding input analog video signal S_{Vin} is to be recorded with changing from the permanent recording mode to the temporary recording mode, without recording being performed in the permanent recording mode. More specifically, this determining means is designed to make a determination based on, for example, an instruction by the user as to whether or not to change to a temporary recording mode. The controller 34 is also provided with temporary recording instructing means for recording the video data in the recording portion 15 in the temporary recording mode when the above-described determining means determines to change to the temporary recording mode.

When the recording portion 15 has the reproduced data erasing means and temporarily recorded data erasing means as described above, the controller 34 comprises temporary recording start instructing means for instructing the data linkage 14 to start temporary recording of the data of the data linkage 14 in the recording portion 15 according to the operating mode of the above-described apparatus and supplied CGMS data and reproduction start instructing means for instructing the recording portion 15 to start reproduction of the temporarily recorded video data before the end of temporary recording. This controller 34 further comprises reproduced data erasure instructing means for instructing the recording portion 15 to erase the reproduced video data from the recording portion 15 in the temporary recording mode immediately after reproduction and temporary recording data erasure instructing means for instructing to erase the video data in the recording portion 15 in the temporary recording mode when reproduction is not started before the end of temporary recording and when reproduction of video data is not performed at the end of temporary recording.

The processor 10 further comprises a video reproduction processor 16 that converts the above-described color difference signal to an output video signal, a copy control data adding portion 17 that adds information of the macrovision signal to the output video signal generated, a video D/A converter 18 that converts the output video signal to an analog signal and generates an analog video output signal S_{Vout} an audio reproduction processor 23 that processes the above-described formatted audio data and an audio D/A converter 24 that converts this audio data to an analog signal and generates an analog audio output signal S_{Aout}. The processor 10 preferably comprises an OSD display generator 19 that generates information when OSD (On Screen Display) displaying a message from the apparatus to the user.

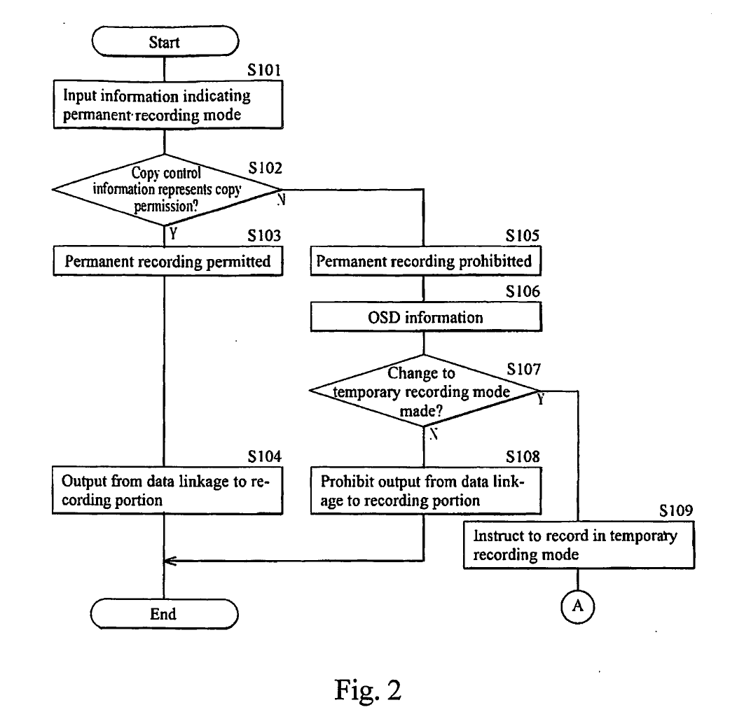

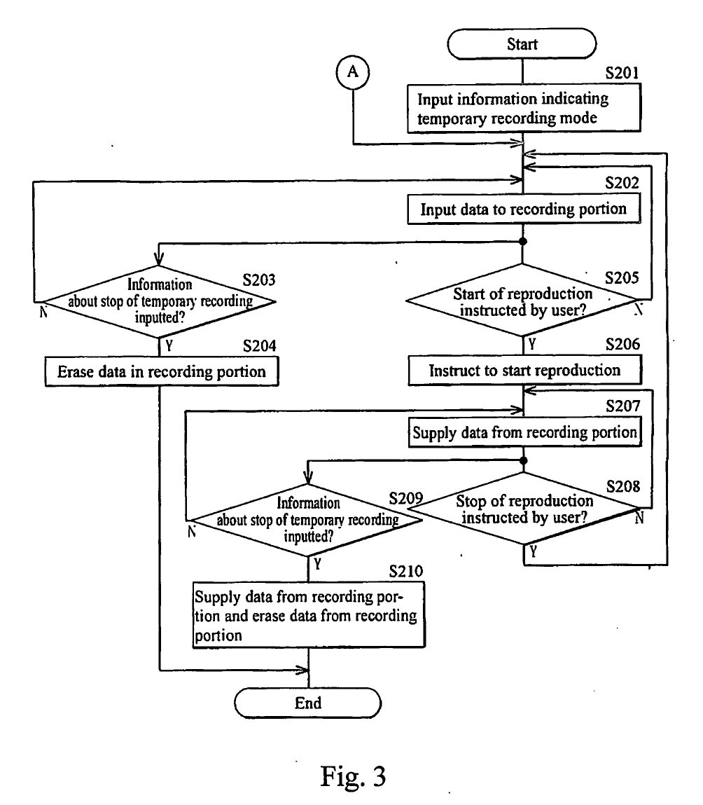

Then, the operation of the data recording/reproducing device of this embodiment will be explained using FIG. 1, FIG. 2 and FIG. 3. The following explanations also serve as explanations of the data processing method according to this embodiment.

When CGMS data is added and an analog AV input signal S_{AVin} with a macrovision signal added as required is inputted, a video signal S_{Vin} and analog audio input signal S_{Ain} are extracted. The extracted analog audio input signal S_{Ain} is converted to a digital signal by the audio A/D converter 21 and formatted by the audio processor 22. On the other hand, the extracted analog video input signal S_{Vin} is converted to a digital signal by the video A/D converter 11, separated into a brightness signal component and a color signal component by the Y/C separator 12, subjected to predetermined processing by the video data processor 13, converted to a color difference signal and sent to the data linkage 14. Furthermore, the video data processor 13 extracts macrovision signal added portion and CGMS data and the macrovision signal added portion is supplied to the macrovision detector 31 and the CGMS data is supplied to the CGMS decoder 32. Furthermore, according to these operations, recording/reproducing mode information of the analog video input signal S_{Vin} supplied from the user interface 41 is supplied to the recording/reproducing mode information decoder 33. The macrovision detector 31 detects whether or not the macrovision signal is added. The CGMS decoder 32 and recording/reproducing mode information decoder 33 decode the CGMS data and recording/reproducing mode information, respectively and the decoded data and information are supplied to the controller 34.

The above-described operations are common when the apparatus is in an operating state of any one of a permanent recording mode, temporary recording mode, direct reproducing mode and read reproducing mode, that is, no matter what recording/reproducing mode information may be inputted to the apparatus. The following operations will be explained for each mode.

FIG. 2 is a flowchart illustrating the processing when the recording/reproducing mode information supplied to the controller 34 indicates a permanent recording mode. When the information indicating the permanent recording mode is inputted from the recording/reproducing mode information decoder 33 to the controller 34 (step S101), the controller 34 determines whether the inputted CGMS data has copy permission information or never copy information (step S102). When the inputted CGMS data has copy permission information (step S102;Y), the input video signal S_{Vin} is determined as permanent recording permitted (step S103) and an instruction is sent to the data linkage 14 to output video data, audio data and CGMS data from the data linkage 14 to the recording portion 15. When the instruction is sent, the video data, audio data and CGMS data are output from the data linkage 14 to the recording portion 15 in response to this instruction (step S104).

On the other hand, when the inputted CGMS data has never copy information (step S102;N), the input video signal S_{Vin} is determined as permanent recording prohibited (step S105), this determination result is sent to the OSD display generator 19 and the OSD display generator 19 generates OSD display information for notifying the user that permanent recording is not possible and OSD display information for presenting to the user a selection whether or not change from the permanent recording mode to the temporary recording mode (step S106). Then, when, for example, a message based on this data appears on a display (not shown), the user inputs information for instructing whether the operation of the apparatus related to the input video signal S_{Vin} is to be terminated or the permanent recording mode is to be changed to the temporary recording mode to record the video data to the apparatus. This information is supplied to the controller 34 (more specifically, determining means) and based on this information, the controller 34 determines whether or not the input video signal S_{Vin} is to be changed from the permanent recording mode to the temporary recording mode to record the video data (step S107). As a result, when it is determined not to change to the temporary recording mode (step S107; N), an instruction for prohibiting the outputting of the video data and audio data from the data linkage 14 to the recording portion 15 is sent to the data linkage 14 (step S108). Furthermore, when it is determined to change to the temporary recording mode (step S107; Y), the controller 34 (more specifically, temporary recording instructing means) instructs the data linkage 14 to record the input analog video signal S_{Vin} in the recording portion 15 in the temporary recording mode (step S109). Then, the controller 34 moves onto step S202 in FIG. 3 which will be described later and carries out the subsequent processing until step S210.

FIG. 3 is a flowchart illustrating the processing when the recording/reproducing mode information supplied to the controller 34 indicates the temporary recording mode. When the information indicating the temporary recording mode is inputted from the recording/reproducing mode information decoder 33 to the controller 34 (step S201), the controller 34 gives an instruction to start temporary recording to the data linkage 14. This allows the data in the data linkage 14 to be output to the recording portion 15 (step S202).

After the data of the data linkage 14 is outputted to the recording portion 15, the controller 34 is placed in an information input waiting state and monitors whether the information about stop of temporary recording has been inputted or not (step S203). The information about stop of temporary recording includes information about stop of a real-time program broadcasting and specification by the user of the end of temporary recording. When the information about stop of temporary recording is inputted (step S203;Y), the controller 34 instructs the recording portion 15 to erase the data in the recording portion 15 and the recording portion 15 erases the data based on this instruction (step S204). In this way, the data in the recording portion 15 is erased if data reproducing is not started before the end of temporary recording irrespective of which information of copy permission or copy prohibited the inputted CGMS data has.

On the other hand, when the information about stop of temporary recording is not inputted (step S203; N), the data of the data linkage 14 continues to be outputted to the recording portion 15 (step S202).

When the data in the data linkage 14 is outputted to the recording portion 15 (step S202), the controller 34 monitors whether the user has instructed the start of reproduction or not (step S205). When the user has instructed the start of reproduction (step S205; Y), the controller 34 instructs the recording portion 15 to start (or restart) reproduction of the data temporarily recorded in the recording portion 15 (step S206). The recording portion 15 supplies the video data and CGMS data to the video reproduction processor 16 and supplies the audio data to the audio reproduction processor 23 (step S207) and in this way reproduction of the data is started (restarted). Furthermore, when the start of reproduction is not instructed (step S205; N), the data in the data linkage 14 continues to be outputted to the recording portion 15 (step S202).

When the recording portion 15 supplies the data as described above (step S207), the controller 34 monitors whether stop of reproduction has been instructed by the user or not (step S208). When the stop of reproduction has been instructed (step S208;Y), the controller 34 instructs the recording portion 15 to stop reproduction of the data temporarily recorded in the recording portion 15 and the recording portion 15 stops supplying video data, audio data and CGMS data based on this instruction. On the other hand, when the stop of reproduction has not been specified (step S208; N), the recording portion 15 continues to supply the above-described data (step S207).

While the recording portion 15 is supplying the data (step S207), the controller 34 monitors whether information about stop of temporary recording has been inputted or not (step S209). When the information about stop of temporary recording has been inputted (step S209; Y), only reproduction of data is performed. In this case, the controller 34 (more specifically, reproduced data erasure instructing means) instructs the recording portion 15 to erase the reproduced data from the recording portion 15 immediately after the reproduction and the recording portion 15 supplies the above-described data to a predetermined location based on this instruction and erases the data from the recording portion 15 immediately after the data is supplied (step S210). That is, the data temporarily recorded in the recording portion 15 is erased from the recording portion 15 immediately after the data is reproduced irrespective of which information of copy permission or copy prohibited the inputted CGMS data has.

On the other hand, when the information about stop of temporary recording has not been inputted (step S209; N), data is continued to be supplied from the recording portion 15 (step S207).

Though not shown in FIG. 3, when reproduction is not performed at the end of temporary recording and there is still non-reproduced part in the stored data, the controller 34 (more specifically, temporary recording data erasure instructing means) instructs the recording portion 15 to erase the non-reproduced part and the recording portion 15 erases the data based on this instruction. That is, the non-reproduced part in the recording portion 15 is erased if the data is not reproduced at the end of temporary recording irrespective of which information of copy permission or copy prohibited the inputted CGMS data has.

When the video data and audio data recorded in the recording portion 15 are read and reproduced in the above-described permanent recording mode, if an instruction of reading/reproduction is given, the video data, audio data and CGMS data are supplied from the recording portion 15 to the data linkage 14. Of these data, the audio data is processed by the audio reproduction processor 23, converted to an analog signal by the audio D/A converter 24 and an analog audio output signal S_{Aout} is generated in this way. On the other hand, the video data is used by the video reproduction processor 16 as the output video signal and supplied to the copy control data adding portion 17. The CGMS data is also supplied to the controller 34 and the information on the macrovision signal is reconstructed from the CGMS data and the information on the reconstructed macrovision signal is sent to the copy control data adding portion 17. The copy control data adding portion 17 adds the information on the macrovision signal to the video data and supplies the information on the video data, CGMS data and macrovision signal to the video D/A converter 18. The video D/A converter 18 converts the video data to an analog signal and generates an analog video output signal S_{Vout} with the information on the CGMS data and macrovision signal added and outputs the signal together with the above-described analog audio output signal S_{Aout} from the processor 10.

Furthermore, in the case of a mode in which the input analog video signal S_{Vin} is reproduced directly, the data linkage 14 is instructed to output the data of the data linkage 14 to the video reproduction processor 16 or audio reproduction processor 23 based on the CGMS data of the controller 34. When the instruction is sent, the CGMS data is supplied to the data linkage 14 and in response to the above-described instruction, the video data and CGMS information and audio data are outputted from the data linkage 14 to the video reproduction processor 16 or audio reproduction processor 23, respectively. The operations thereafter are the same as those in the case of the above-described reading/reproducing mode.

Thus, according to this embodiment, when never copy information is inputted as copy control information and information on the permanent recording mode is inputted as the recording/reproducing mode information, it is determined whether the data is recorded by stopping the operation of the apparatus about the input video signal S_{Vin} or changing the input video signal S_{Vin} from the permanent recording mode to the temporary recording mode, and when it is determined to change to the temporary recording mode, recording of the input video signal S_{Vin} in the temporary recording mode is instructed, and therefore when the audiovisual signal inputted to the processor 10 is accompanied by copy control information with never copy information and information for specifying the permanent recording mode, it is possible to prohibit permanent recording and perform temporary recording. It is also possible to increase the degree of freedom in utilization by the user.

Furthermore, when the permanent recording mode is changed to the temporary recording mode and temporary recording of data in the recording portion 15 is started, if start of reproduction of data temporarily recorded in the recording portion before the end of temporary recording is instructed, the reproduced data is erased from the recording portion immediately after the reproduction and if the reproduction is not started before the end of temporary recording and data has not been reproduced at the end of temporary recording, the non-reproduced data temporarily recorded in the recording portion 15 is erased, and therefore even if the analog AV input signal S_{AVin} with copy control information with never copy information added is inputted, it is possible to perform time shift reproduction without the data temporarily recorded in the recording portion 15 being copied. Therefore, when never copy information is added to the analog audiovisual signal inputted to the processor 10, it is possible to reflect the intention of “never copy” of the program supplier and perform the above-described time shift reproduction.

The above-described embodiment has described the case where the recording portion 15 includes the reproduced data erasing means and the temporarily recorded data erasing means and the controller 34 includes the reproduced data erasure instructing means and the temporarily recorded data erasure instructing means, but these means need not always be provided.

Furthermore, the above-described embodiment has described the case where analog video data is inputted, but the present invention is also applicable to a case where digital video data is inputted and the effects of the present invention can also be obtained in that case, too.

Furthermore, the above-described embodiment has described the input data processing as a data recording/reproducing device, but this data processing may also be implemented as software. For example, the present invention may also be adapted in such a way that a data processing program of the present invention is stored in a ROM (Read Only Memory) and operations are performed according to the program under instructions from a CPU (Central Processing Unit). Furthermore, the present invention may also be adapted so as to store this program in a computer-readable storage medium, record a data processing program in this storage medium in a RAM (Random Access Memory) of the computer and perform operations according to the data processing program. The operations and effects similar to those in the above-described embodiment can also be obtained in this case, too.

Furthermore, the above-described embodiment has described the case where CGMS data and macrovision signal are added to an input video signal and these data are processed by the CGMS decoder and macrovision detector, but the additional information added to the input video signal may be any one of these data or may be additional information other than these data.

Moreover, the above-described recording portion 15 may also be provided with a plurality of recording media and this is effective when the user is interested in three or more TV broadcast programs provided on the same time zone.

### APPLICATION EXAMPLE

Suppose the user views a first program in real time (direct reproducing mode), records a second program in a first recording medium in a permanent recording mode and views it at a time later than the program broadcasting time. At this time, if the second program is a copy-prohibited program, the user is notified through the above-described OSD display from the apparatus that permanent recording is not available. In that case, the user changes the permanent recording mode to the temporary recording mode and records the second program and can view it from a time a little earlier than the time at which program broadcasting ends.

Based on the above-described explanations, it is obvious that it is possible to implement various modes and modification examples of the present invention. Therefore, within the equivalent scope of the following claims, it is possible to implement the present invention according to modes other than the modes detailed above.

This application is based on the International Application PCT/IB03/01482 filed on Apr. 10, 2003, entire content of which is expressly incorporated by reference herein.

### INDUSTRIAL APPLICABILITY

The present invention is applicable to a television set, etc., provided with a recording medium capable of digital recording such as an HDD.

1. A data recording/reproducing device provided with a processor for receiving data including video data, first additional information to control a copy of the video data and second additional information to control a type of recording and/or reproducing the video data and for processing the received data, the processor having a recording portion capable of carrying out recording in a permanent recording mode for permanently recording the received video data or in a temporary recording mode for temporarily recording the received video data, characterized in that said processor comprises:
means for determining whether the video data is to be recorded with changing from the permanent recording mode to the temporary recording mode, without recording being performed in the permanent recording mode, when never copy information is received as the first additional information and information of the permanent recording mode is received as the second additional information; and
a means for instructing to record the video data on the recording portion in the temporary recording mode when it is determined by said determining means to record the video data with changing to the temporary recording mode.

2. The data recording/reproducing device as claimed in claim 1, characterized in that the video data is analog data.

3. The data recording/reproducing device as claimed in claim 1, characterized in that said processor has an ability to perform recording and reproducing at the same time, and further comprises a means for instructing to start reproducing the video data temporarily recorded on the recording portion before the end of recording in the temporary recording mode when the change from the permanent recording mode to the temporary recording mode is made and a means for erasing the video data in the recording portion immediately after information about stop of storing in the temporary recording mode is received.

4. A data processing method including a processing input data including video data, first additional information to control a copy of the video data and second additional information to control a type of recording and/or reproducing the video data, in which recording can be carried out in a permanent recording mode for permanently recording the received video data or in a temporary recording mode for temporarily recording the received video data, characterized in that said processing includes:
determining whether or not the video data is to be recorded with changing from the permanent recording mode to the temporary recording mode, without recording being performed in the permanent recording mode, when never copy information is received as the first additional information and information of the permanent recording mode is received as the second additional information; and
instructing to record the video data in the temporary recording mode when it is determined to record the video data with changing to the temporary recording mode.

5. A program operable on a computer for processing data including video data, first additional information to control a copy of the video data and second additional information to control a type of recording and/or reproducing of the video data, characterized in that said program comprises the functions for:
determining whether or not the video data is to be recorded with changing from a permanent recording mode to a temporary recording mode, without recording being performed in the permanent recording mode, when never copy information is received as the first additional information and information of the permanent recording mode is received as the second additional information; and
instructing to record the video data in the temporary recording mode when it is determined to record the video data with changing to the temporary recording mode.
